(19) United States
(12) Patent Application Publication
(10) Pub. No.: US 2026/0003807 A1
(43) Pub. Date: Jan. 1, 2026

(54) Variable Access Latency with Storage Array Extensions on Stacked Dies

(71) Applicant: Advanced Micro Devices, Inc., Santa Clara, CA (US)

(72) Inventors: Gabriel Hsiuwei Loh, Bellevue, WA (US); Brian William Thompto, Austin, TX (US); John J. Wuu, Fort Collins, CO (US); Christopher Spence Oliver, Austin, TX (US); Justin Allan Coppin, Windsor, CO (US); John M. King, Austin, TX (US); Anthony Joseph Blybell, Chapel Hill, NC (US); Anthony Jarvis, Acton, MA (US)

(73) Assignee: Advanced Micro Devices, Inc., Santa Clara, CA (US)

(21) Appl. No.: 18/757,325

(22) Filed: Jun. 27, 2024

(51) Int. Cl. G06F 13/16; G06F 12/0811

(52) U.S. Cl. CPC G06F 13/1689; G06F 12/0811

(57) ABSTRACT

Variable access latency with storage array extensions on stacked dies. In one or more implementations, a system includes a storage array having a plurality of storage circuits implemented on different dies in a stack of dies, and control logic operable to receive responses from the storage circuits in reply to storage circuit requests forwarded through the stack of dies and output the responses according to a respective latency that delays each response based on a characteristic of a corresponding storage circuit that provides the response. In at least one implementation, a device includes a control logic that outputs responses from a stacked storage array having a plurality of storage circuits according to a respective latency that delays each response based on a characteristic of a corresponding storage circuit that provides the response.

### BACKGROUND

A die is a piece of semiconductor material used to fabricate an integrated circuit for a semiconductor device. Semiconductor devices often include multiple dies, including vertically stacked dies that help achieve a small footprint and improve electrical performance.

### BRIEF DESCRIPTION OF THE DRAWINGS

FIG. 1 is a block diagram of a non-limiting example system that uses variable access latency with storage array extensions on stacked dies.

FIG. 2 is a block diagram of another non-limiting example system that uses variable access latency with storage array extensions on stacked dies.

FIG. 3 depicts a timing diagram of communications exchanged in a non-limiting example system using variable access latency with storage array extensions on stacked dies.

FIG. 4 depicts a record maintained in furtherance of using variable access latency with storage array extensions on stacked dies.

FIG. 5 depicts a procedure for using variable access latency with storage array extensions on stacked dies.

FIG. 6 is a block diagram of a processing system configured to execute one or more applications, in accordance with one or more implementations.

### DETAILED DESCRIPTION

Processing devices, such as a central processing unit (CPU), a graphics processing unit (GPU), an accelerator unit, a system on chip (SoC), and the like, are semiconductor devices implemented on semiconductor dies. A processing device typically includes a base die (also referred to as a main die) used to provision a processor core and various other elements that support the core.

Storage arrays (e.g., a cache, a translation lookaside buffer, register files) are often collocated on the base die with the core to improve performance. Chip size (e.g., area) is a cost limiting factor in semiconductor design because larger chips are more expensive to manufacture. In one or more cases, storage array performance is restricted to satisfy a footprint size. To improve performance (e.g., use a greater quantity of cache-levels, expand storage capacity) without consuming additional area on the base die, a storage array extension may be implemented on a stack of dies. The stack arranges the storage array extension just above or below the base die (e.g., to be as close as possible to the core).

A storage array extension often includes individual storage circuits implemented on different dies within the stack. Vertical distance between the base die and each storage circuit varies depending on a stack position within the stack of a supporting die. Other unique characteristics of the storage circuits include a material (e.g., a Silicon type), a storage circuit capacity (e.g., a storage circuit speed corresponds to a size or capacity of the storage circuit), a layout type (e.g., effecting die-to-die crossing latency or die-to-die timing margin), and a slower/faster circuit technology, for example. When taken together, the variation in characteristics of individual storage circuits causes access latency to the storage array extension to be different. For example, storage circuits implemented on higher positioned dies in the stack (e.g., a stack position at a greater vertical distance from the processor) take longer to access than storage circuits implemented on lower positioned dies in the stack (e.g., a stack position closer to the processor). As another example, due to variation in storage circuit technology, responses from a storage circuit using slower circuit technology has a greater latency than responses from a storage circuit implemented with faster circuit technology, even if the slower storage circuit is closer in stack position to the processor.

To ease complexity of accessing storage array extensions, a conventional system assumes a worst-case, response latency of the storage array extension for each storage circuit request. For example, even if requested data is transferrable from a storage circuit that is implemented lower in the stack, a reduced complexity hinders an improved processing time by delaying access to the data as if a highest die (e.g., a slowest storage circuit) is being accessed. Although a consistent response latency simplifies accesses to the storage array extension, applying a worst-case response latency for each storage circuit request limits overall performance of the storage array extension.

Variable access latency with storage array extensions on stacked dies is described herein for improving performance when accessing a vertically stacked storage array from a base die. With variable access latency with storage array extensions, response latency is not set to a worst-case latency associated with a slowest storage circuit. Instead, a response latency of an example storage array is set based on a characteristic of a storage circuit being accessed within the stack. Examples of a storage circuit characteristic from which the response latency is based on include a stack position, a material (e.g., a type of Silicon or substrate), a circuit technology, a storage capacity or size, a layout type (e.g., complex layout, simple layout) effecting die-to-die crossing latency or die-to-die timing margin, or other property of the storage circuit that effects data transfer rates when accessing the stack. For example, when a response latency is based on stack position, a storage circuit that is close to the main circuit (e.g., lower in the stack) is allowed to be shorter than response latencies of storage circuits that are further away (e.g., higher in the stack). As another example, when response latency is based on circuit technology, material, capacity or size, or type of layout, a storage circuit with faster technology, higher-performance material, smaller capacity, or less-complex layout is able to respond to requests with less latency than a slower-performing storage circuit implemented with slower technology, lesser-performance material, greater capacity, or more-complex layout. As such, processing delays are reduced, and overall performance is improved.

By way of example, a system includes a main circuit and a stacked storage array. The main circuit is integrated on a base semiconductor die and includes at least one requestor component or element (e.g., a processor, a processor core) configured to generate and/or consume data. The stacked storage array includes a plurality of storage circuits that are operable to store and/or recall the data produced by the main circuit. The storage circuits are implemented on a stack of dies, which in at least one aspect includes the base die arranged vertically relative (e.g., above, below) one or more other dies.

Each of the storage circuits is communicatively coupled to the main circuit through an interconnect. The interconnect runs through the stack to implement an interface between the main circuit and the storage circuits. For example, the interconnect is configured to receive storage requests from the main circuit. The requests are forwarded by the interconnect (e.g., through the stack) to one or more responsible storage circuits, which store or retrieve data to fulfill the requests. Responses are generated by the storage circuits in response to the requests. The interconnect is operable to send the responses back through the stack and out to the main circuit.

In at least one example, two or more of the storage circuits are identical copies and have at least one similar or same characteristic. In one or more aspects, two or more of the storage circuits have at least one different characteristic. For example, implementing the storage circuits on different stacked dies causes at least two of the storage circuits to be located at a distinct distance from the main circuit, in addition to possibly having other distinct characteristics. A first die in the stack includes the base die and implements a storage circuit that is adjacent to the main circuit. Each subsequent stacked die implements a second storage circuit that is positioned further from the main circuit than a previous die in the stack. In at least one aspect, because each of the storage circuits is located at a different distance from the main circuit, each storage circuit has a different length signal propagation path to the main circuit. Other variations in the storage circuits characteristics are possible, which leads to performance differences depending on which storage circuit is being accessed. In one or more implementations, this variation in storage circuit characteristics causes a response latency at two or more of the storage circuits to be different. For example, responses generated by the first storage circuit on the base die to take more or less time to reach the main circuit than responses generated by at least one second storage circuit implemented on other stacked dies.

To avoid having to access the storage array using a same (e.g., worst-case) response latency for each request, the system includes control logic adjacent to the main circuit on the base die to improve performance. The control logic is operable to output responses using a respective latency that is set for each response, which is based on a characteristic (e.g., stack position, a material, a circuit technology, a storage capacity or size, a layout type, or other property of the storage circuit that effects data transfer rates through the stack) of a corresponding storage circuit that generates that response. Overall response time of the storage array is improved by enabling a different access latency to each of the stacked dies. For example, the control logic maintains information indicating a worst-case latency associated with each storage circuit. When a request for access to the storage array extension is received, the control logic applies the response latency specific to the storage circuit that is responsible for the request. In at least one implementation, the control logic maintains a table having an entry for a response latency to apply to each storage circuit. When a request is received, the control logic accesses the table to look up the response latency for the storage circuit handling the request.

Unlike a conventional system that delays each response according to a worst-case latency for the entire stack, each response is delayed for a specific time allotted to the specific storage circuit that is responsible for handling the request. Data that is transferable from a faster storage circuit is made available in response to a request quicker than data that is transferable from a slower storage circuit.

By applying a storage-circuit-specific response latency to each individual request, access latency and overall performance of a stacked storage array is improved. Processing time is not wasted by delaying responses according to a worst-case latency determined across the stack. Responses to some requests are allowed to occur faster even if responses to other requests happen slower. In this way, a storage array is not limited by a slowest storage circuit (e.g., a worst-case latency) and performance improves.

In at least one example, controlling the response latency for individual storage requests promotes efficient execution of different tasks. For example, storage requests provided during execution of a time-sensitive or urgent task are handled by a shorter-latency storage circuit. Storage requests provided during execution of less urgent tasks (e.g., background tasks) are addressed by accessing a longer-latency storage circuit. In this way, tasks that depend on access to a storage array are not limited by performance of its slowest parts. Performance of urgent tasks is improved using low latency storage circuits to address urgent storage requests, and performance of less urgent tasks is maintained using higher latency storage circuits to address less urgent storage requests.

Another benefit to enabling finer control over the response latency of a storage array is in enabling variation in storage circuit designs. For example, expensive (e.g., faster) circuit technology implemented on some of the stacked dies is co-mingled in the stack with cheaper (e.g., slower) circuit technology for other dies in the stack. A fast performing storage circuit implemented with a first type of circuit technology is not impacted by a longer access latency to a slower performing storage circuit, which is implemented with a different type of circuit technology than the first type. In one or more implementations, with sufficient performance gains from the faster circuitry, the slower circuitry is allowed to be even slower. For example, if a faster part of the stack sufficiently improves an average response latency for the storage array, then other parts of the stack are allowed to operate with an even slower response latency, which saves costs.

In one or more aspects, the techniques described herein relate to a system including a storage array having a plurality of storage circuits implemented on different dies in a stack of dies, and control logic operable to receive responses from the storage circuits in reply to storage circuit requests forwarded through the stack of dies, and output the responses according to a respective latency that delays each response based on a characteristic of a corresponding storage circuit that provides the response. In one or more aspects, the techniques described herein relate to a system, wherein the control logic is further operable to cause a different response latency between two or more storage circuits in the stack of dies.

In one or more aspects, the techniques described herein relate to a system, wherein the characteristic of the corresponding storage circuit includes a stack position of the corresponding storage circuit.

In one or more aspects, the techniques described herein relate to a system, wherein the characteristic of the corresponding storage circuit includes a material of the corresponding storage circuit.

In one or more aspects, the techniques described herein relate to a system, wherein the characteristic of the corresponding storage circuit includes a circuit technology of the corresponding storage circuit.

In one or more aspects, the techniques described herein relate to a system, wherein the characteristic of the corresponding storage circuit includes a storage capacity of the corresponding storage circuit.

In one or more aspects, the techniques described herein relate to a system, wherein the characteristic of the corresponding storage circuit includes a layout type of the corresponding storage circuit.

In one or more aspects, the techniques described herein relate to a system, wherein the control logic is further operable to forward the storage circuit requests through the stack of dies, set the respective latency for each of the responses, and for each of the responses, check the stack of dies for that response after waiting for the respective latency set for that response.

In one or more aspects, the techniques described herein relate to a system, wherein the control logic is operable to determine a respective worst-case latency for each storage circuit in the stack of dies, and set the respective latency of each storage circuit to be the respective worst-case latency determined for that storage circuit.

In one or more aspects, the techniques described herein relate to a system, wherein the control logic is operable to maintain a record of individual latencies associated with the storage circuits in the stack of dies, and set the respective latency of each storage circuit to be an individual latency maintained in the record for that storage circuit.

In one or more aspects, the techniques described herein relate to a system, wherein the control logic is implemented on a same semiconductor die as a first storage circuit in the stack of dies.

In one or more aspects, the techniques described herein relate to a system, further including a processor implemented on a same semiconductor die in the stack of dies as the control logic, wherein the storage array includes a cache for the processor and each of the storage circuits include a different cache level of the cache.

In one or more aspects, the techniques described herein relate to a system, further including a processor implemented on a same semiconductor die in the stack of dies as the control logic, wherein the storage array comprises a cache for the processor and each of the storage circuits comprise storage capacity of a same cache level of the cache.

In one or more aspects, the techniques described herein relate to a device including control logic that outputs responses from a stacked storage array having a plurality of storage circuits according to a respective latency that delays each response based on a characteristic of a corresponding storage circuit that provides the response.

In one or more aspects, the techniques described herein relate to a device, wherein the control logic is operable to cause a different response latency between two or more storage circuits in the stacked storage array.

In one or more aspects, the techniques described herein relate to a device, wherein the characteristic of the corresponding storage circuit includes a stack position and the control logic is operable to set the respective latency of a first storage circuit in the stacked storage array to be shorter than the respective latency of a last storage circuit in the stacked storage array.

In one or more aspects, the techniques described herein relate to a device, wherein the control logic is further operable to set the respective latency of a second storage circuit in the stacked storage array to be longer than the respective latency of the first storage circuit and shorter than the respective latency of the last storage circuit.

In one or more aspects, the techniques described herein relate to a device, wherein the control logic is operable to maintain a record of individual latencies associated with the storage circuits in the stacked storage array, and set the respective latency of each storage circuit to be an individual latency maintained in the record for that storage circuit.

In one or more aspects, the techniques described herein relate to a device, wherein the control logic is implemented on a same semiconductor die as a first storage circuit in the stacked storage array.

In one or more aspects, the techniques described herein relate to a device, further including a processor implemented on the same semiconductor die as the control logic and the first storage circuit.

In one or more aspects, the techniques described herein relate to a method including receiving, by control logic, a request to a stacked storage array having a plurality of storage circuits implemented on a stack of dies, identifying, by the control logic, a characteristic of a corresponding storage circuit that generates a response to the request, setting, by the control logic, a respective latency for the response based on the characteristic, and delaying, by the control logic, an output of the response according to the respective latency determined for the response.

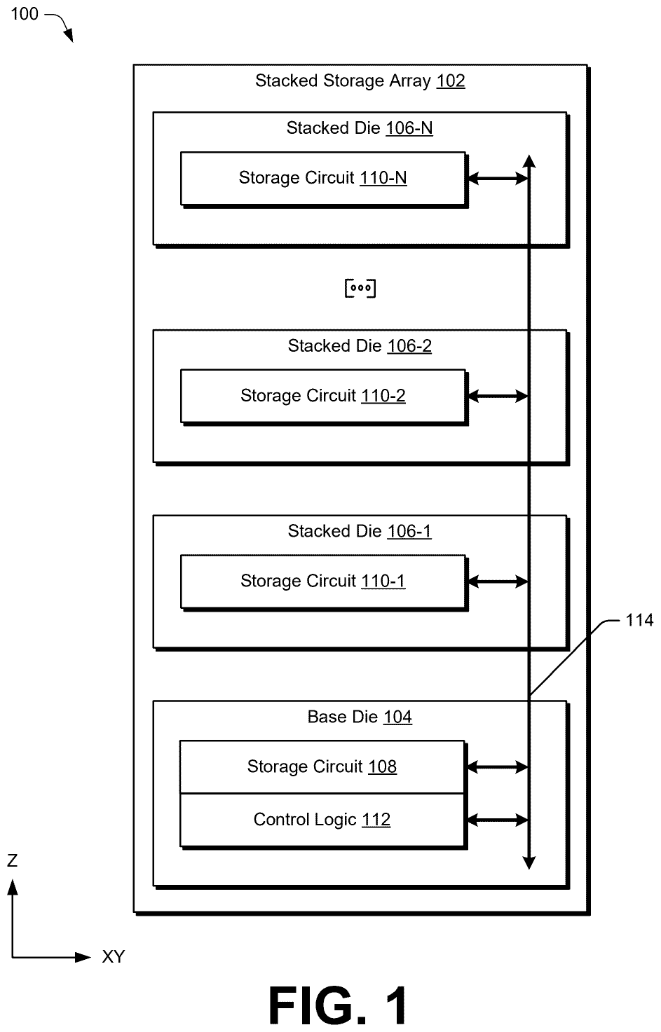

FIG. 1 is a block diagram of a non-limiting example system 100 that uses variable access latency with storage array extensions on stacked dies. In this example, the system 100 represents an example of a stacked storage array 102, which is implemented on multiple stacked semiconductor dies. It is to be appreciated that in variations, and without departing from the spirit or scope of the described techniques, the system 100 and the individual components illustrated therein include more, fewer, and/or different hardware components (e.g., a processor core, additional caches, networking interfaces, other controllers, memory, accelerator cores). In one example for instance, an interface to a processor core is operable with an interface of the stacked storage array 102.

The system 100 is part of any type of processing system, device, or apparatus that benefits from a storage array or storage array extension. Examples of systems, devices, and apparatuses in which the system 100 is implemented include, but are not limited to, one or more server computers, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer, and other computing devices or systems.

The stacked storage array 102 includes hardware components, referred to as storage circuits, that are configured as a data store, a memory, or a storage to store data (e.g., at least temporarily) so that a future request for the data is served from the stacked storage array 102. Examples of a data store, a memory, or a storage implemented by the stacked storage array 102 include a cache, a translation lookaside buffer, a register file, a latch array, a static random-access memory (SRAM), a dynamic RAM (DRAM), non-volatile memory of various technologies, and so forth.

The system 100 causes the stacked storage array 102 to be available to one or more requestors (not shown). The term “requestor” as used herein represents an individual or group of processing elements that read and execute instructions (e.g., of a program), examples of which include to add, to move data, and to branch. Examples of a requestor that utilizes the stacked storage array 102 include, but are not limited to, a processor, a processing core, a CPU, a GPU, a field programmable gate array (FPGA), an accelerator, an accelerated processing unit (APU), an intelligent processing unit (IPU), a neural processing unit, and a digital signal processor (DSP), an elevator controller, a cache controller, a system on chip, to name a few.

The stacked storage array 102 has a plurality of storage circuits implemented on different dies from a stack of dies. In at least one aspect, each of the storage circuits of the stacked storage array 102 is an electronic circuit implemented on a different die in the stack of dies to implement at least a portion of the data store, the memory, or the storage of the stacked storage array 102. For example, the stacked storage array 102 includes an electronic storage circuit integrated within a base die 104 and electronic storage circuits integrated within each of a stacked die 106-1 through a stacked die 106-N, where “N” represents a quantity of N stacked dies of any integer greater than zero.

The base die 104 and each of the stacked die 106-1 through the stacked die 106-N is an individual piece of semiconductor material used to fabricate a particular storage circuit of the stacked storage array 102. Numerous examples of semiconductor materials usable to form the base die 104 and the stacked die 106-1 through the stacked die 106-N exist including, by non-limiting example, silicon, sapphire, ruby, gallium arsenide, glass, or any other semiconductor material. In one or more examples, using different materials among the storage circuits contained in the stacked storage array 102 cause response latencies of two or more of the storage circuits to be different. For example, the stacked die 106-1 implements the storage circuit 110-1 using an inexpensive silicon material that causes accesses to take longer than accesses at the storage circuit 110-2, which is implemented on the stacked die 106-2 using an expensive, high-performance silicon material.

The base die 104 is arranged on an XY-plane and the stacked die 106-1 through the stacked die 106-N are positioned one on top of another either above or below the base die 104. For example, the stacked die 106-1 through the stacked die 106-N are stacked in a Z-dimension along a Z-axis that is normal to the XY-plane on which the base die 104 is arranged. The stacked die 106-1 through the stacked die 106-N are individually labeled, in order of increasing distance from the base die 104, as a stacked die 106-1 through stacked die 106-N.

The base die 104 and each of the stacked die 106-1 through the stacked die 106-N implement a different storage circuit of the stacked storage array 102. For example, the base die 104 includes a single storage circuit labeled as a storage circuit 108, which represents a first layer of the stacked storage array 102. The stacked die 106-1 through the stacked die 106-N collectively support a quantity of N storage circuits, which are individually labeled as a storage circuit 110-1 through a storage circuit 110-N. In one or more aspects, the storage circuit 110-1 through a storage circuit 110-N are configured as one or more second layers of the stacked storage array 102 that provide storage capacity beyond the first layer implemented by the storage circuit 108 on the base die 104.

In one or more examples, the storage circuit 108 and the storage circuit 110-1 through the storage circuit 110-N are identical copies of each other. For example, the storage circuit 108 and each of the storage circuit 110-1 through the storage circuit 110-N includes an equal amount of data storage capacity or is implemented using similar storage circuit technology. In other implementations, two or more of the storage circuit 108 and the storage circuit 110-1 through the storage circuit 110-N are different. For example, the storage circuit 108 has a different storage capacity than the storage circuit 110-1, which has a different or similar storage capacity to a storage circuit 110-2 and/or the storage circuit 110-N. As one example, the storage circuit 108 is configured to store one hundred twenty eight kilobytes of data and the storage circuit 110-2 is configured to store two hundred fifty six kilobytes of data. In at least one example, the storage circuit 108 uses different circuit technology than one or more of the storage circuit 110-1 through the storage circuit 110-N. For example, the storage circuit 108 has faster circuitry than one or more of the storage circuit 110-1 through the storage circuit 110-N, and is operable to respond to storage requests with less response latency than one or more of the storage circuit 110-1 through the storage circuit 110-N, which have slower circuitry. As one example, the storage circuit 108 is implemented using six-transistor cell SRAM technology and one or more of the storage circuit 110-1 through the storage circuit 110-N is implemented using four-transistor cell SRAM technology. The six-transistor cell SRAM technology causes the storage circuit 108 to serve storage requests faster than the four-transistor cell SRAM technology used by the one or more of the storage circuit 110-1 through the storage circuit 110-N. In at least one example, the storage circuit 108 has a different layout type than one or more of the storage circuit 110-1 through the storage circuit 110-N. For example, the storage circuit 108 has a simple layout type with links within the base die 104 that provides a first (e.g., small) crossing latency between different regions of the base die 104, and the storage circuit 110-1 has a complex layout type with links within the stacked die 106-1 that cause a second (e.g., larger than the first) crossing latency between different regions of the stacked die 106-1. The simple layout type enables the storage circuit 108 to respond to storage requests with less response latency than the storage circuit 110-1, which uses a more complex layout type.

Being on the base die 104, the storage circuit 108 typically has a lowest access latency of the stacked storage array 102 compared to the storage circuit 110-1 through the storage circuit 110-N. For example, being the closest level of the stacked storage array 102 to a main circuit implemented on the base die 104 enables the storage circuit 108 to have the lowest access latency of the stacked storage array 102.

Also referred to as a storage array extension (e.g., a cache extension), the second layers of storage of the stacked storage array 102 are implemented by the storage circuit 110-1 through the storage circuit 110-N. Each of the storage circuit 110-1 through the storage circuit 110-N are further away from the base die 104 than the storage circuit 108. The storage circuit 110-1 through the storage circuit 110-N are configured to support at least one additional layer of storage beyond the first layer of storage implemented by the storage circuit 108. For example, the storage circuit 110-1 and the storage circuit 108 make up the stacked storage array 102, and the storage circuit 110-2 through the storage circuit 110-N are omitted from the storage array 102. In one or more examples, the storage circuit 110-1 through the storage circuit 110-N have progressively higher positions in the stacked storage array 102. In at least one implementation, the progressively higher positions in the stack cause the storage circuits to have progressively higher levels of access latency compared to the storage circuit 108. For example, the storage circuit 110-1 has a fastest access latency among the storage circuit 110-1 through the storage circuit 110-N, with the storage circuit 110-N having the slowest access latency.

In one or more implementations, the stacked storage array 102 is a cache and the storage circuit 108 is a first level (e.g., level 0, level 1, N level) of the cache with a first level of access latency. The storage circuit 110-1 through the storage circuit 110-N form next levels (e.g., level 1, level 2, N+1 level) of the cache that go beyond the first level cache. Each of the storage circuit 110-1 through the storage circuit 110-N have a longer access latency than the first level of access latency provided by the storage circuit 108. In at least one variation, when the stacked storage array 102 is a cache, the storage circuit 108 is a first level of the cache with a first level of access latency and the storage circuit 110-1 through the storage circuit 110-N expand capacity of the first level of the cache with a second level of access latency that is different (e.g., slower) than the first level of access latency associated with the storage circuit 108. In this way, access to the first level of cache varies depending on the storage circuit being accessed. A slower part of the first level of cache is implemented by the storage circuit 110-1 and a faster part of the first level of cache is implemented by the storage circuit 108, as one example.

The system 100 includes control logic 112 configured to consume responses and/or results from the stacked storage array 102. The control logic 112 is an electronic circuit that manages the retrieval, storage, and delivery of data at the stacked storage array 102. For example, the control logic 112 implements an interface to a requestor of the stacked storage array 102. In one or more implementations, the control logic 112 is implemented on the base die 104. In at least one variation, the control logic 112 is implemented on one or more of the base die 104 and the stacked die 106-1 through the stacked die 106-N. A requestor communicates over the interface in the control logic 112 to store data into, or load data from, the stacked storage array 102. In one or more implementations, the requestor is implemented on the base die 104. In at least one variation, the requestor is implemented on one or more of the base die 104 and the stacked die 106-1 through the stacked die 106-N. For example, the requestor is integrated on the stacked die 106-N in at least one implementation. In at least one variation, the control logic 112 and the requestor are implemented on a same die among one or more of the base die 104 and the stacked die 106-1 through the stacked die 106-N. In at least one other variation, the control logic 112 and the requestor are implemented on different dies among two or more of the base die 104 and the stacked die 106-1 through the stacked die 106-N. The communication from the requestor causes the control logic 112 to send requests to the storage circuit 108 and/or the storage circuit 110-1 through the storage circuit 110-N. The control logic 112 process responses received from the storage circuit 108 and/or the storage circuit 110-1 through the storage circuit 110-N and sends the responses to the requestor.

An interconnect 114 of the system 100 is configured to facilitate communications between the control logic 112 and the stacked storage array 102, including the storage circuit 108 and the storage circuit 110-1 through the storage circuit 110-N. For example, the interconnect 114 is configured to receive responses from the storage circuit 108 and the storage circuit 110-1 through the storage circuit 110-N in reply to storage circuit requests forwarded by the control logic 112 to the stacked storage array 102. In at least one example, the interconnect 114 is implemented within the stacked storage array 102 to pass vertically (e.g., along the Z-axis) from the base die 104 and through each of the stacked die 106-1 through the stacked die 106-N. The interconnect 114 communicatively couples or links the control logic 112 to the storage circuit 108 on the base die 104 and the storage circuit 110-1 through the storage circuit 110-N implemented, respectively, on the stacked die 106-1 through the stacked die 106-N. For example, the interconnect 114 communicatively links the stacked die 106-1 to the base die 104, as well as linking to the stacked die 106-2, and so forth, up to and including the stacked die 106-N.

In one or more implementations, the interconnect 114 includes interface technology configured to electrically couple each of the storage circuit 108 and the storage circuit 110-1 through the storage circuit 110-N to at least one adjacent layer from the stacked storage array 102. For example, the interconnect 114 includes micro bumps, hybrid bonds, through-silicon vias, or other interface technology that couples the base die 104 to the stacked die 106-1, the stacked die 106-2, and so forth, up to and including the stacked die 106-N. In at least one implementation, the interconnect 114 includes one or more types of interface technology that couple the storage circuit 110-2 to the storage circuit 110-1, as well as various kinds of interface technology that couples the storage circuit 110-N to the storage circuit 110-2 or to a storage circuit 110-N−1 (not shown).

In accordance with the described techniques, the control logic 112 is operable to cause a different response latency between different storage circuits in the stacked storage array 102. Instead of a conventional approach of applying a worst-case access latency to the stacked storage array 102 in its entirety, the control logic 112 is configured to consume results/responses from the stacked storage array 102 according to the respective access latency associated with an individual die or storage circuit where data is being stored or retrieved.

For example, the control logic 112 is operable to output the responses (e.g., from the storage circuit 108 and the storage circuit 110-1 through the storage circuit 110-N) using a respective latency set for each response. In one or more implementations, a response to a request at the storage circuit 108 has a first level of access latency (e.g., a fastest access latency), and a response to a request at the storage circuit 110-N has a second level of access latency (e.g., a slowest access latency). The control logic 112 consumes requests and responses at a rate consistent with the access latency associated with a responding storage circuit of the stacked storage array 102. The control logic 112 checks the interconnect 114 for a response from the storage circuit 110-N after delaying for an amount of time consistent with the access latency associated with the storage circuit 110-N. After the delay associated with the storage circuit 110-N, the response to a request at the storage circuit 110-N is output from the control logic 112. The control logic 112 checks the interconnect 114 for a response from the storage circuit 108 after delaying for an amount of time consistent with an access latency associated with the storage circuit 108, which is similar or different from the access latency associated with the storage circuit 110-N. After this delay associated with the storage circuit 108, the response to a request at the storage circuit 108 is output from the control logic 112.

The latency set by the control logic 112 for each response is based on a characteristic of a corresponding storage circuit that generates that response. For example, when the latency is set based on stack position, the control logic 112 is operable to set the respective latency of a first storage circuit in the stack (e.g., the storage circuit 108) to be shorter than the respective latency of a second storage circuit in the stack (e.g., the storage circuit 110-N). In one aspect, the requests to the storage circuit 108 and the storage circuit 110-N are forwarded through the interconnect 114 close in time (e.g., one after the other, in parallel). The control logic 112 checks the interconnect 114 for the response from the storage circuit 108 and for the response from the storage circuit 110-N according to the respective access latency that the control logic 112 applies to each. For example, prior to checking the interconnect 114 for the response from the storage circuit 110-N according to the respective access latency set for the storage circuit 110-N, the control logic 112 checks the interconnect 114 for the response from the storage circuit 108 according to the respective access latency set for the storage circuit 108.

In at least one implementation, the control logic 112 is further operable to set the respective latency of a second storage circuit in the stack to be shorter than the respective latency of a first storage circuit. For example, the storage circuit 110-1 is implemented with slower circuit technology than the storage circuit 110-2. Due to the variation in circuit technology performance, the control logic 112 is operable to set the respective latency of the storage circuit 110-1 to be a second level of access latency (e.g., a slower access latency), and the respective latency of the storage circuit 110-2 is set to a first level of access latency (e.g., a fastest access latency). For example, the requests to the storage circuit 110-1 and the storage circuit 110-2 are forwarded through the interconnect 114 close in time (e.g., one after the other, in parallel). The control logic 112 checks the interconnect 114 for the response from the storage circuit 110-2 prior to checking the interconnect 114 for the response from the storage circuit 110-1.

The control logic 112 on the base die 104 is configured to provide access to the stacked storage array 102 with a variable latencies that depend on characteristics of the one or more individual stacked dies being accessed. If an individual die is present, the control logic 112 maintains information about a worst-case latency associated with that individual die. For example, the control logic 112 determines (e.g., based on a fuse setting associated with the stacked storage array 102) whether each of the stacked die 106-1 through the stacked die 106-N is present. In at least one example, the control logic 112 is operable to maintain a record of latencies, having a latency entry for each individual die in the stack or each circuit (if more than one circuit per die, or more than one die per circuit). Within each record entry, the control logic 112 stores an expected latency for accesses at that die and checks for responses at a rate consistent with this expected latency.

In one or more aspects, the control logic 112 is operable to set the respective latency of each response based on a function of time that increases between a first relative stack position and a last relative stack position. For example, the control logic 112 determines a relative stack position of a storage circuit responsible for a request and the function of time derives the response latency used by the control logic 112 to check for a response. The function, in at least one example, sets the response latency to be progressively higher as the relative stack position increases for accessing storage circuits located higher in the stack (e.g., further from the base die 104).

In one or more implementations, the appropriate response time is preprogrammed in the control logic 112 or within other logic accessible to the control logic 112 from the stacked storage array 102. For example, the control logic 112 executes instructions that extract the response latencies for individual storage circuits in the stacked storage array 102 at run-time.

In one or more examples, the control logic 112 measures the response latency for each die in the stacked storage array 102 and adjusts the appropriate response time going forward. For example, the control logic 112 executes instructions that test the response latencies of each individual storage circuit in the stacked storage array 102 during an initialization step, which occurs prior to run-time.

When a request for access to the stacked storage array 102 is received, the control logic 112 determines a response latency specific to the circuit responsible for the request. For example, the control logic 112 determines a storage circuit identifier associated with a storage circuit responsible for a request and based on the identifier, looks up the expected latency for that circuit from the record.

Difference in latencies can be managed by the control logic 112 in various ways. In a cache implementation, a cache hit and a cache miss can happen in parallel accesses to the stacked storage array 102. When a cache hit occurs from a faster part of the stacked storage array 102, the cache hit proceeds as usual and is not slowed by a cache miss in the slower part. When a cache miss happens in the fast part of the stacked storage array 102, but a cache hit occurs in the slow part, the cache hit effectively appears like an overall cache hit that is somewhat slower.

For example, the control logic 112 forwards a cache request to the die that has an appropriate cache bank. The control logic 112 forwards the storage circuit requests through the interconnect 114. Then, the control logic 112 sets the respective latency for each of the responses to the requests. After waiting an appropriate amount of time (e.g., processor cycles) before checking for a response (e.g., whether a cache hit/cache miss), the control logic 112 consumes the response from the interconnect 114. For example, for each of the responses, the control logic 112 checks the interconnect 114 for that response after waiting for the respective latency set for that response.

Unlike conventional techniques that delay each response according to a worst-case latency for the entire stack, each response is delayed only for a specific time allotted to the specific circuit that is responsible for handling the request. In this way, processing time is not wasted by delaying accesses according to a worst-case access latency for the entire stack. Data that is transferred from a lower or faster die in the stacked storage array 102 is made available to the control logic 112 for responding to a request quicker than data that is transferred from a higher or slower die in the stacked storage array 102. By applying a specific response latency to each individual request, overall performance of stacked storage array 102 is improved.

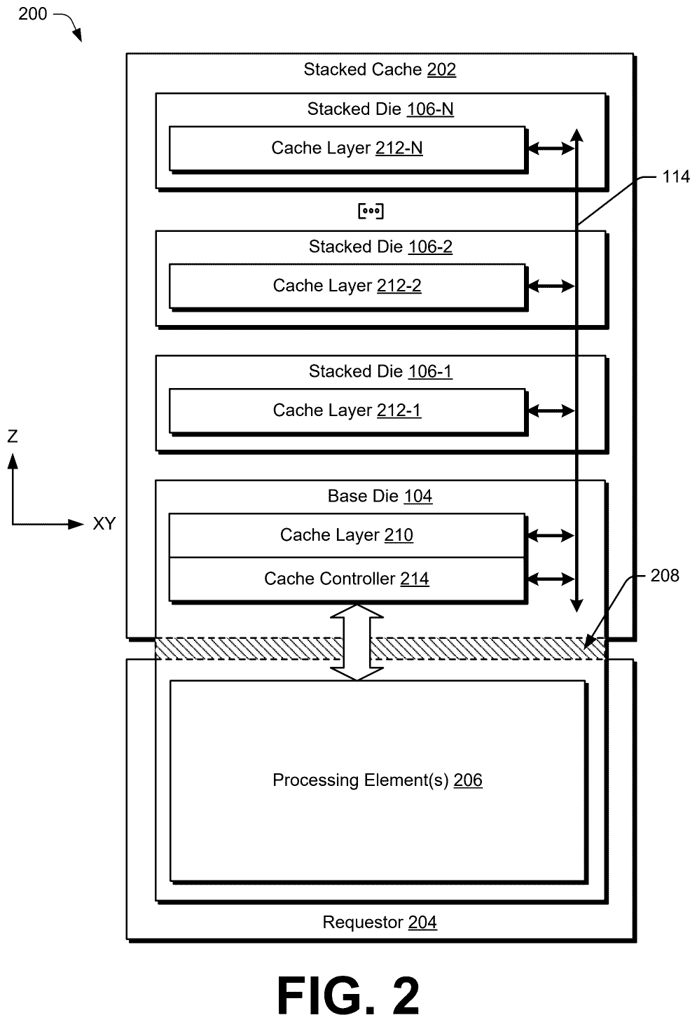

FIG. 2 is a block diagram of another non-limiting example system 200 that uses variable access latency with storage array extensions on stacked dies. The system 200 represents an example of a stacked cache implementation of the system 100. The system 200 includes a stacked cache 202 formed from the base die 104 and the stacked die 106-1 through the stacked die 106-N, which are arranged in the Z-dimension above or below each other. In addition, the system 200 includes the interconnect 114, which communicatively couples the base die 104 to each of the stacked die 106-1 through the stacked die 106-N. The stacked cache 202 represents an example of a stacked cache implementation of the stacked storage array 102.

A requestor 204 of the system 200 includes one or more processing elements 206 to perform processing operations, such as, reading and executing instructions (e.g., of a program, from software, from firmware). Examples of the requestor 204 and the processing elements 206 include, but are not limited to, a processing core, a CPU, a GPU, a FPGA, an accelerator, an APU, an IPU, and a DSP, to name a few. As depicted in FIG. 2, the processing elements 206 of the requestor 204 are arranged on the base die 104, where the processing elements 206 are operatively and communicatively coupled to the stacked cache 202. For example, the processing elements 206 execute instructions that require data to be loaded or stored at the stacked cache 202. In at least one variation, the requestor 204 and the processing elements 206 thereof are implemented on one or more of the base die 104 and the stacked die 106-1 through the stacked die 106-N.

The cache controller 214 is an example of the control logic 112 that is configured to implement cache operations on the stacked cache 202. In one or more examples, the processing elements 206 of the requestor 204 represent a processor of the system 200, which is implemented on a same semiconductor die as the control logic (e.g., the cache controller 214). In at least one variation, the cache controller 214 and the requestor 204 are implemented on a same die among one or more of the base die 104 and the stacked die 106-1 through the stacked die 106-N. For example, the processing elements 206, the cache layer 210, and the cache controller 214 are each arranged on the base die 104. However, the processing elements 206 are formed opposite a region 208 of the base die 104 that separates the stacked cache 202 from the requestor 204. In at least one other variation, the cache controller 214 and the requestor 204 are implemented on different dies among two or more of the base die 104 and the stacked die 106-1 through the stacked die 106-N. For example, the processing elements 206 of the requestor 204 are integrated on the base die 104 with the cache layer 210, and the cache controller 214 is implemented on the stacked die 106-1 with the cache layer 212-1.

In one or more implementations, the stacked cache 202 is smaller than other data stores accessible to the requestor 204, faster at serving data to the requestor 204 than these other data stores, and/or more efficient at serving data to the requestor 204 than these other data stores. Additionally, or alternatively, the stacked cache 202 is located closer to the processing elements 206 than other data stores within the system 200. It is to be appreciated that in various implementations the stacked cache 202 has additional or different characteristics that make serving at least some data from the stacked cache 202 to the processing elements 206 advantageous over serving such data from other data stores in the system 200.

The stacked cache 202 has a plurality of storage circuits communicatively coupled by control logic, which in this example is a cache controller 214. In one or more examples, the stacked cache 202 is implemented at least partially in software or implementable in different ways without departing from the spirit or scope of the described techniques. The stacked cache 202 includes a cache implemented on the base die 104 and a cache extension implemented on the stacked die 106-1 through the stacked die 106-N.

The cache layer 210 and each of the cache layer 212-1 through the cache layer 212-N are different storage circuits of the stacked cache 202. For example, the cache layer 210 is implemented by a first storage circuit on the base die 104, and the cache layer 212-1 through the cache layer 212-N are implemented by second storage circuits on the stacked die 106-1 through the stacked die 106-N. In at least one implementation, the cache layer 210 is a different cache level (e.g., a L0 cache) of the stacked cache 202 than the cache layer 212-1 through the cache layer 212-N (e.g., a L1 cache, a L2 cache, a L3 cache, a LN cache) implemented by the second storage circuits of the stacked cache 202. In at least one variation, the cache layer 210 is a part of a same cache level of the stacked cache 202 as the cache layer 212-1 through the cache layer 212-N. For example, the cache layer 210 provides a first portion of the stacked cache 202 (e.g., a first part of a L1 cache) and the cache layer 212-1 through the cache layer 212-N implement additional capacity of the stacked cache 202 (e.g., a second part of the L1 cache).

The cache controller 214 determines where to store new data, when to fetch additional data from adjacent addresses to be ready in case the requestor 204 will use the data soon after, and what old data to discard from the stacked cache 202 if cache memory within the stacked cache 202 is full. In one or more implementations, to improve performance of the stacked cache 202, the cache controller 214 maintains a table of addresses associated with data already stored in the stacked cache 202. The cache controller 214 checks the table to determine if the requestor 204 is referencing data that is already present in memory of the stacked cache 202.

The cache controller 214 enables an interface to the stacked cache 202. For example, the interface controlled by the cache controller 214 receives messages from the processing elements 206 indicating data to be stored at or retrieved from the stacked cache 202. Based on the messages obtained from the requestor 204, the cache controller 214 generates cache requests that are sent via the interconnect 114 to the cache layer 210 and the cache layer 212-1 through the cache layer 212-N. For example, the cache controller 214 requests data be loaded or stored at one or more of the cache layer 210 and the cache layer 212-1 through the cache layer 212-N to satisfy the requestor 204. When a response is ready, the cache controller 214 outputs the response to the interface, for use by the requestor 204. The cache controller 214 coordinates transfers of data to and from the cache layer 210 and the cache layer 212-1 through the cache layer 212-N by issuing cache layer requests to the interconnect 114, and processing cache layer responses received through the interconnect 114.

In operation, the cache controller 214 is configured to apply a variable latency to responses generated for requests the cache controller 214 receives from the requestor 204. Responses from the cache layer 210 and the cache layer 212-1 through the cache layer 212-N are output from the cache controller 214 using a respective latency set for each response that is based on a characteristic of a responding storage circuit, which generates that response. For example, the cache controller 214 receives a cache request from the processing elements 206. The cache controller 214 determines a responding storage circuit for handling the cache request. The cache controller 214 determines whether the cache layer 210, the cache layer 212-1 through the cache layer 212-N manages storage or retrieval of data associated with the cache request. In this example, assume the cache layer 212-2 is responsible for responding to the cache request.

Upon forwarding the cache request through the interconnect 114 for receipt by the cache layer 212-2, the cache controller 214 determines a response latency for that request. The cache controller 214 looks up a predetermined latency associated with the cache layer 212-2 and sets a response timer to determine when the cache controller 214 is to check the interconnect 114 for a response. Rather than use a worst-case latency for the stacked cache 202, the cache controller 214 uses a specific latency determined for the cache layer 212-2. For example, instead of setting the response timer to a worst-case latency of the stacked cache 202 overall, the cache controller 214 improves performance of the stacked cache 202 by delaying a response until the latency for the cache layer 212-2 expires. This way, the cache controller 214 is not forcing the requestor 204 to wait for additional time when the response is ready sooner.

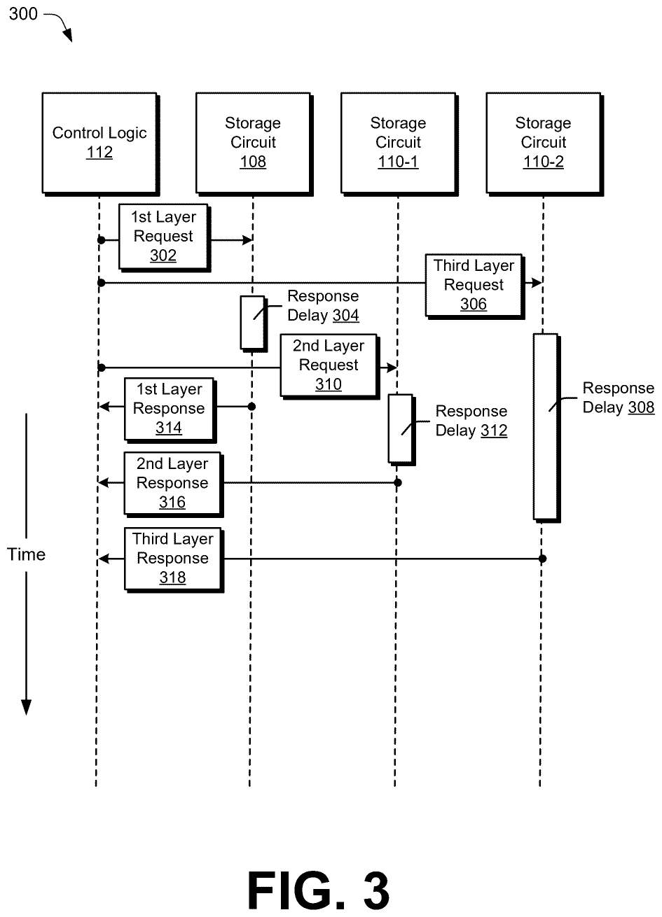

FIG. 3 depicts a timing diagram 300 of communications exchanged in a non-limiting example system using variable access latency with storage array extensions on stacked dies. In accordance with the described techniques, the timing diagram 300 conveys operations performed by a system or a device (e.g., a semiconductor device) that includes a stacked storage array having a plurality of storage circuits. For ease of description, the timing diagram 300 is described in the context of the system 100, including with reference to similar labeled elements of FIG. 1. For example, a temporal order of operations and/or communications associated with the control logic 112 and the storage circuit 108, the storage circuit 110-1, and the storage circuit 110-2 is shown in FIG. 3. Time increases from the top of FIG. 3 to the bottom of FIG. 3, as indicated by a downward pointing arrow.

In one or more examples, the control logic 112 splits up storage array requests into different portions of data. Each portion is sent to a different one of the storage circuit 108, the storage circuit 110-1, and the storage circuit 110-2, which enables the stacked storage array 102 to process each part of the request in parallel. For example, assume each of the storage circuit 108, the storage circuit 110-1, and the storage circuit 110-2 is configured to process one thousand pieces of data. The storage circuit 110-1 and the storage circuit 110-2 implement two storage layers beyond the storage circuit 108. A function at the control logic 112 maps data for the stacked storage array 102 to be distributed (e.g., evenly) among the three different cache layers. In practice, each of the storage circuit 108, the storage circuit 110-1, and the storage circuit 110-2 receives a request indicating an addressable data location and a specific quantity of bits corresponding to unique part of the data stored at that address. For example, the first third of bits at the address is processed by the storage circuit 108 in response to a first request on the interconnect 114, the second third of bits at the address is processed by the storage circuit 110-1 in response to a second request on the interconnect 114, and so forth, until the final third of bits at the address is processed by the storage circuit 110-2 in response to a third request on the interconnect 114.

The timing diagram 300 illustrates an order of operations and/or communications that travel up and down the interconnect 114 regardless of whether cache requests are split into multiple requests or requests are each referencing entire blocks of data. On the base die 104, the control logic 112 causes a request 302 for access to the storage circuit 108 to appear on the interconnect 114 during a first cycle. After issuing the request 302, the control logic 112 sets a response delay 304 to delay how fast the control logic 112 checks for a response from the storage circuit 108 in response to the request 302. For example, the response delay 304 is one cycle long based on a characteristic of the storage circuit 108 indicating faster storage accesses are possible with the storage circuit 108 than the storage circuit 110-1 and the storage circuit 110-2.

The control logic 112 causes a request 306 for access to the storage circuit 110-2 to appear on the interconnect 114. After issuing the request 306, the control logic 112 sets a response delay 308 to control how soon the control logic 112 checks for a response from the storage circuit 110-2 in response to the request 306. For example, the response delay 308 is N cycles long (e.g., more than two cycles long) based on the corresponding characteristic of the storage circuit 110-2 indicating slower storage accesses happen with the storage circuit 110-2 than are possible with the storage circuit 108 and the storage circuit 110-1.

Finally, in this example, the control logic 112 causes a request 310 for access to the storage circuit 110-1 to appear on the interconnect 114. After issuing the request 310, the control logic 112 sets a response delay 312 to delay how fast the control logic 112 checks for a response from the storage circuit 110-1 in response to the request 310. For example, the response delay 312 is two cycles long based on a characteristic of the storage circuit 110-1 indicating storage accesses are slower with the storage circuit 110-1 than the storage circuit 108 and faster with the storage circuit 110-1 than the storage circuit 110-2.

A response 314 to the request 302 is generated by the storage circuit 108. After the response delay 304 expires, the response 314 is retrieved from the interconnect 114. For example, the response 314 is buffered by the interconnect 114 to prevent the response 314 from reaching the control logic 112 until the response delay 304 expires (e.g., after one cycle), at which point the control logic 112 outputs the response 314 to a requestor.

A response 316 to the request 310 is generated by the storage circuit 110-2. After the response delay 312 expires, the response 316 is retrieved from the interconnect 114. For example, the response 316 is delivered by the interconnect 114 to the control logic 112 when the response delay 312 expires (e.g., after two cycles), at which point the control logic 112 outputs the response 316 to the requestor.

Finally, a response 318 to the request 306 is generated by the storage circuit 110-2. After the response delay 308 expires, the control logic 112 retrieves the response 318 from the interconnect 114. For example, the response 318 is kept at the interconnect 114 to prevent the response 318 from being received by the control logic 112 until the response delay 308 expires (e.g., after N cycles), at which point the control logic 112 outputs the response 318 to the requestor.

In this way, in response to receiving the request 302, the request 306, and the request 310 at approximately a same time from the requestor, the control logic 112 outputs corresponding responses quickly, for example, without waiting for each of the response 314, the response 316, and the response 318 to be ready. The response 314 is output first in time from the storage circuit 108, the response 316 is output second in time from the storage circuit 110-1, and the response 318 is output last in time from the storage circuit 110-2.

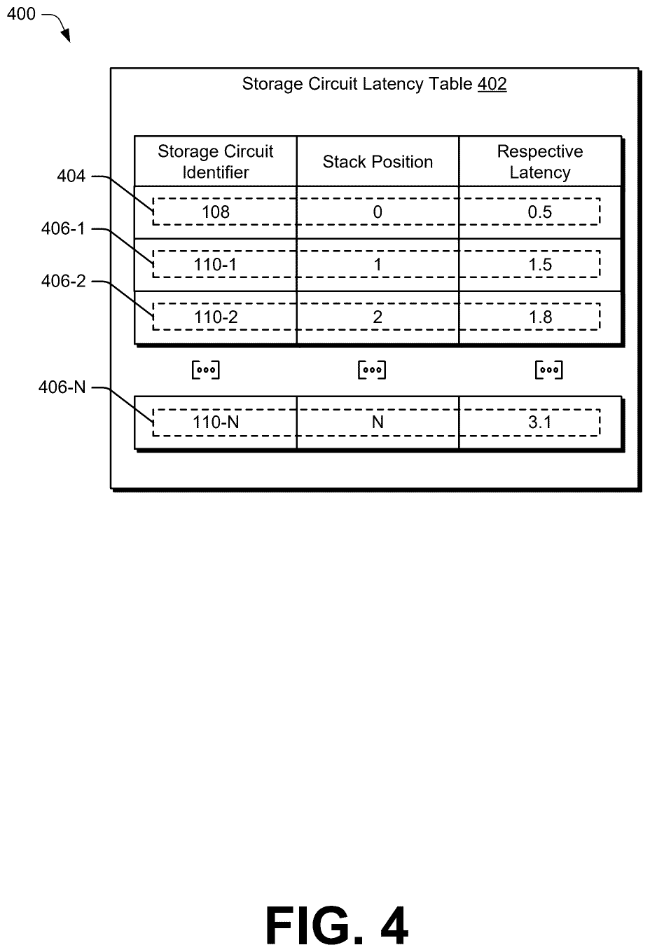

FIG. 4 depicts a record 400 maintained in furtherance of using variable access latency with storage array extensions on stacked dies. For ease of description, the record 400 is described in the context of the system 100 and the timing diagram 300, including with reference to similar labeled elements depicted in FIG. 1 and FIG. 3.

At manufacturing time of the system 100, or during initialization of the system 100 in one or more examples, the control logic 112 determines a respective worst-case latency for each storage circuit in the stacked storage array 102. The control logic 112 sets the respective latency of each storage circuit to be the respective worst-case latency determined for that storage circuit. For example, the control logic 112 generates the record 400 to be a storage circuit latency table (referred to simply as a table 402). Each row of the table 402 is associated with a different storage circuit in the stacked storage array 102. For example, a first row 404 includes a storage circuit identifier, a stack position, and a worst-case response latency associated with the storage circuit 108. A second row 406-1 includes similar information as the first row 404 but for the storage circuit 110-1. A third row 406-2 includes a storage circuit identifier, a stack position, and a worst-case response latency associated with the storage circuit 110-2, and a last row 406-N includes similar information as the third row 406-2, but for the storage circuit 110-N.

The control logic 112 populates the entries of the table 402 to allow future determinations of an appropriate response latency to assign to requests intended for different parts of the stacked storage array 102. In this way, the control logic 112 maintains the table 402 as the record 400 of individual latencies associated with the storage circuits in the stacked storage array 102.

In one or more implementations, the control logic 112 preprograms the appropriate response latency at manufacturing time or based on a configuration file or initialization step performed to ready the system 100 for operation. For example, the control logic 112 executes instructions that extract the response latencies for individual storage circuits in the stacked storage array 102 at run-time and populates the response latencies in the table 402.

In one or more examples, the response latency for each die in the stacked storage array 102 is pre-determined (e.g., at design time) and preconfigured or preloaded in the table 402 at the time of manufacturing. In one or more implementations, the control logic 112 determines the response latency for each die in the stacked storage array 102 and sets the appropriate response times in the table 402 to apply to future requests.

In at least one implementation, the control logic 112 is configured to set the respective latency of each storage circuit to be an individual latency maintained in the record 400 for that storage circuit. For example, the control logic 112 executes instructions to test a response latency of the storage circuit 108 and stores a worst-case latency in the first row 404. The control logic 112 tests a response latency of the storage circuit 110-1 and stores a worst-case latency in the second row 406-1. The control logic 112 tests a response latency of the storage circuit 110-2 and stores a worst-case latency in the third row 406-2, and so forth, until the control logic 112 tests a response latency of the storage circuit 110-N and stores a worst-case latency in the last row 406-N.

When a request for access to the stacked storage array 102 is received, the control logic 112 determines a response latency specific to the circuit responsible for the request. In one or more implementations, the control logic 112 determines a position within the stacked storage array 102 associated with a storage circuit responsible for a request and looks up the expected latency for that circuit from the table 402. For example, with reference to FIG. 3, the control logic 112 sets the response delay 304 to be equal to a respective latency associated with the storage circuit 110-1 within the second row 406-1. The control logic 112 sets the response delay 308 to be equal to a respective latency associated with the storage circuit 110-N within the last row 406-N. The control logic 112 sets the response delay 312 to be equal to a respective latency associated with the storage circuit 110-2 within the third row 406-2.

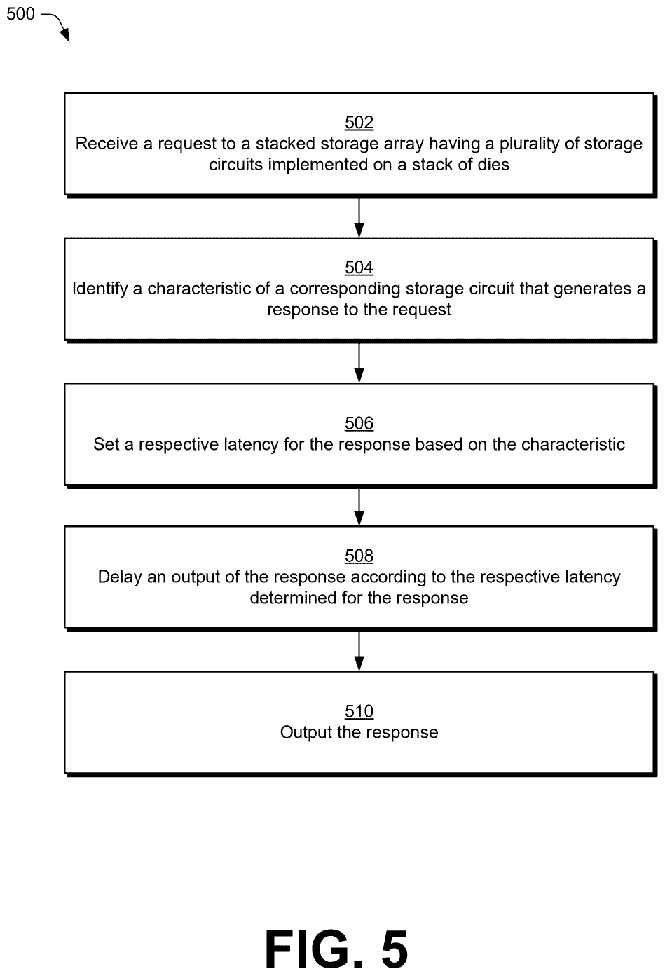

FIG. 5 depicts a procedure 500 for using variable access latency with storage array extensions on stacked dies. The procedure 500 includes multiple operations illustrated as block 502 through block 510 and provides just one example procedure performed within the system 100 and/or the system 200. The procedure 500 is not limited to the order of operations shown in FIG. 5, other orderings of the block 502 through the block 510 are possible. In one or more implementations, the procedure 500 includes additional or fewer operations than those depicted in FIG. 5.

A request to a stacked storage array having a plurality of storage circuits implemented on a stack of dies is received (block 502). For example, the control logic 112 receives a request for data maintained at the storage circuit 110-2 prior to receiving a request for data maintained at the storage circuit 108.

A characteristic of a corresponding storage circuit that generates a response to the request is identified (block 504). In at least one aspect, the control logic 112 identifies or determines that the storage circuit 108 has a smaller capacity or other characteristic than causes the storage circuit 108 to respond faster to requests than the storage circuit 110-2.

A respective latency for the response based on the characteristic is set (block 506). For example, the control logic 112 maintains a record of response latencies to apply to different storage circuits within the stacked storage array 102. From the record, the control logic 112 sets or determines a first response latency to be applied to the storage circuit 108 and a second response latency to be applied to the storage circuit 110-2.

An output of the response according to the respective latency determined for the response is delayed (block 508). As one example, the control logic 112 waits until the first response latency expires prior to checking the interconnect 114 for a response from the storage circuit 108. The control logic 112 waits until the second response latency expires prior to checking the interconnect 114 for a response from the storage circuit 110-2.

The response is output (block 510). For example, without waiting for the response from the storage circuit 110-2, the control logic 112 forwards the response retrieved from the storage circuit 108 to a requestor that generated the request. Later, after the second response latency expires, the control logic 112 forwards the response retrieved from the storage circuit 110-2 to the requestor that generated the request.

Rather than forcing a worst-case response latency for each response to the stacked storage array 102, the procedure 500 causes a response latency at the stacked storage array 102 to be dependent on a worst-case response latency of a responding storage circuit for each specific request. This response scheme improves performance of the stacked storage array 102 by eliminating idle time waiting for an overall worst-case latency of the stacked storage array 102, when a response is available sooner.

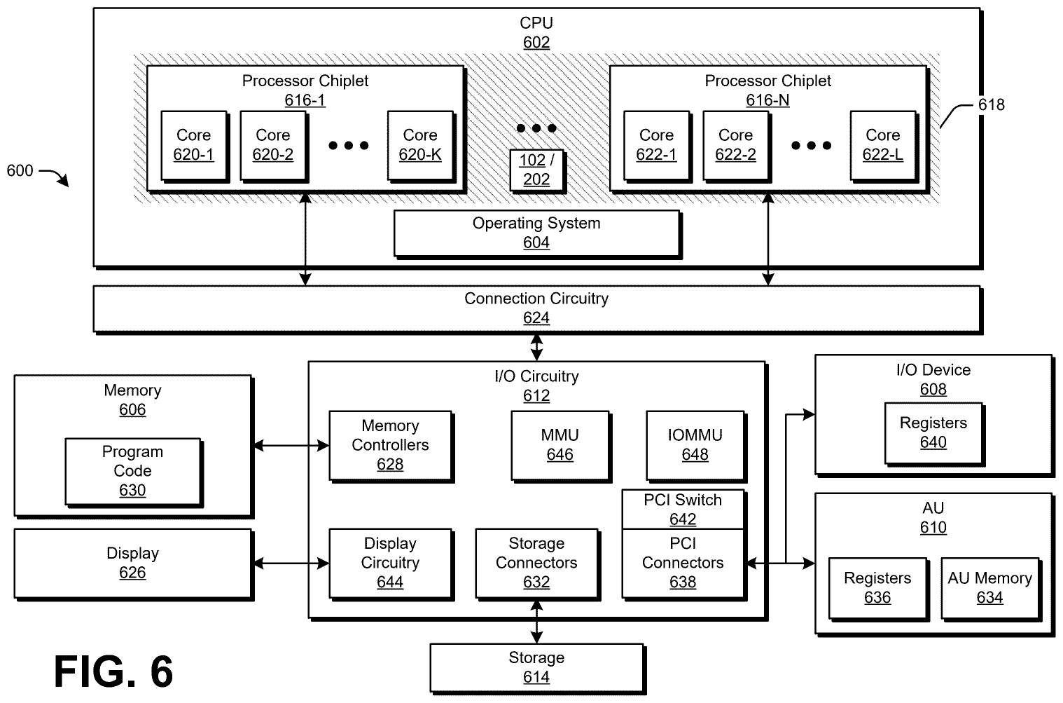

FIG. 6 includes a processing system 600 configured to execute one or more applications, such as compute applications (e.g., machine-learning applications, neural network applications, high-performance computing applications, databasing applications, gaming applications), graphics applications, and the like. Examples of devices in which the processing system is implemented include, but are not limited to, a server computer, a personal computer (e.g., a desktop or tower computer), a smartphone or other wireless phone, a tablet or phablet computer, a notebook computer, a laptop computer, a wearable device (e.g., a smartwatch, an augmented reality headset or device, a virtual reality headset or device), an entertainment device (e.g., a gaming console, a portable gaming device, a streaming media player, a digital video recorder, a music or other audio playback device, a television, a set-top box), an Internet of Things (IoT) device, an automotive computer or computer for another type of vehicle, a networking device, a medical device or system, and other computing devices or systems.

In the illustrated example, the processing system 600 includes a central processing unit (CPU) 602. In one or more implementations, the CPU 602 is configured to run an operating system (OS) 604 that manages the execution of applications. For example, the OS 604 is configured to schedule the execution of tasks (e.g., instructions) for applications, allocate portions of resources (e.g., system memory 606, CPU 602, input/output (I/O) device 608, accelerator unit (AU) 610, storage 614) for the execution of tasks for the applications, provide an interface to I/O devices (e.g., I/O device 608) for the applications, or any combination thereof.

In this example, one or multiple implementations of the stacked storage array 102 and/or the stacked cache 202 are depicted in the CPU 602. In variations, however, one or multiple implementations of the stacked storage array 102 and/or the stacked cache 202 are included in and/or are implemented by one or more different components of the processing system 600, such as the CPU 602, the memory 606, the I/O device 608, the AU 610, the I/O circuitry 612, the storage 614, and so forth. In at least one implementation, the stacked storage array 102 and/or the stacked cache 202 or portions of the stacked storage array 102 and/or the stacked cache 202 are included in at least two of the depicted components of the processing system 600. By way of example, the stacked storage array 102 and/or the stacked cache 202 may be included in or otherwise implemented by at least the CPU 602 and the AU 610.

The CPU 602 includes one or more processor chiplets 616, which are communicatively coupled together by a data fabric 618 in one or more implementations. The one or multiple implementations of the stacked storage array 102 and/or the stacked cache 202 of the CPU 602 are also communicatively coupled via the data fabric 618 to one or a plurality of the processor chiplets 616. For example, the CPU 602 is an example of the requestor 204 and each of the processor chiplets 616 is an example of one or more of the processing elements 206. The processor chiplets 616 are configured to access the stacked storage array 102 and/or the stacked cache 202 of the CPU 602 in at least one variation by communicating and exchanging data over connections or links implemented by the data fabric 618. In one or more examples, the processor chiplets 616 include local implementations of the stacked storage array 102 and/or the stacked cache 202 of the CPU 602 and communicate and exchanging data over internal connections or links implemented within the processor chiplets 616 or separate from the data fabric 618.

Each of the processor chiplets 616, for example, includes one or more processor cores 620, 622 configured to concurrently execute one or more series of instructions, also referred to herein as “threads,” for an application. Further, the data fabric 618 communicatively couples each processor chiplet 616-N of the CPU 602 such that each processor core (e.g., processor cores 620) of a first processor chiplet (e.g., 616-1) is communicatively coupled to each processor core (e.g., processor cores 622) of one or more other processor chiplets 616. Though the example embodiment presented in FIG. 6 shows a first processor chiplet (616-1) having three processor cores (620-1, 620-2, 620-K) representing a K number of processor cores 622 and a second processor chiplet (616-N) having three processor cores (e.g., 622-1, 622-2, 622-L) representing an L number of processor cores 622, in other implementations (L being an integer number greater than or equal to one), each processor chiplet 616 may have any number of processor cores 620, 622. For example, each processor chiplet 616 can have the same number of processor cores 620, 622 as one or more other processor chiplets 616, a different number of processor cores 620, 622 as one or more other processor chiplets 616, or both.

Examples of connections which are usable to implement data fabric include but are not limited to, buses (e.g., a data bus, a system, an address bus), interconnects, memory channels, through silicon vias, traces, and planes. Other example connections include optical connections, fiber optic connections, and/or connections or links based on quantum entanglement.

Additionally, within the processing system 600, the CPU 602 is communicatively coupled to an I/O circuitry 612 by a connection circuitry 624. For example, each processor chiplet 616 of the CPU 602 is communicatively coupled to the I/O circuitry 612 by the connection circuitry 624. The connection circuitry 624 includes, for example, one or more data fabrics, buses, buffers, queues, and the like. The I/O circuitry 612 is configured to facilitate communications between two or more components of the processing system 600 such as between the CPU 602, system memory 606, display 626, universal serial bus (USB) devices, peripheral component interconnect (PCI) devices (e.g., I/O device 608, AU 610), storage 614, and the like.

As an example, system memory 606 includes any combination of one or more volatile memories and/or one or more non-volatile memories, examples of which include dynamic random-access memory (DRAM), static random-access memory (SRAM), non-volatile RAM, and the like. To manage access to the system memory 606 by CPU 602, the I/O device 608, the AU 610, and/or any other components, the I/O circuitry 612 includes one or more memory controllers 628. These memory controllers 628, for example, include circuitry configured to manage and fulfill memory access requests issued from the CPU 602, the I/O device 608, the AU 610, or any combination thereof. Examples of such requests include read requests, write requests, fetch requests, pre-fetch requests, or any combination thereof. That is to say, these memory controllers 628 are configured to manage access to the data stored at one or more memory addresses within the system memory 606, such as by CPU 602, the I/O device 608, and/or the AU 610.

When an application is to be executed by processing system 600, the OS 604 running on the CPU 602 is configured to load at least a portion of program code 630 (e.g., an executable file) associated with the application from, for example, a storage 614 into system memory 606. This storage 614, for example, includes a non-volatile storage such as a flash memory, solid-state memory, hard disk, optical disc, or the like configured to store program code 630 for one or more applications.

To facilitate communication between the storage 614 and other components of processing system 600, the I/O circuitry 612 includes one or more storage connectors 632 (e.g., universal serial bus (USB) connectors, serial AT attachment (SATA) connectors, PCI Express (PCIe) connectors) configured to communicatively couple storage 614 to the I/O circuitry 612 such that I/O circuitry 612 is capable of routing signals to and from the storage 614 to one or more other components of the processing system 600.

In association with executing an application, in one or more scenarios, the CPU 602 is configured to issue one or more instructions (e.g., threads) to be executed for an application to the AU 610. The AU 610 is configured to execute these instructions by operating as one or more vector processors, coprocessors, graphics processing units (GPUs), general-purpose GPUs (GPGPUs), non-scalar processors, highly parallel processors, artificial intelligence (AI) processors (also known as neural processing units, or NPUs), inference engines, machine-learning processors, other multithreaded processing units, scalar processors, serial processors, programmable logic devices (e.g., field-programmable logic devices (FPGAs)), or any combination thereof.

In at least one example, the AU 610 includes one or more compute units that concurrently execute one or more threads of an application and store data resulting from the execution of these threads in AU memory 634. This AU memory 634, for example, includes any combination of one or more volatile memories and/or non-volatile memories, examples of which include caches, video RAM (VRAM), or the like. In one or more implementations, these compute units are also configured to execute these threads based on the data stored in one or more physical registers 636 of the AU 610.

To facilitate communication between the AU 610 and one or more other components of processing system 600, the I/O circuitry 612 includes or is otherwise connected to one or more connectors, such as PCI connectors 638 (e.g., PCIe connectors) each including circuitry configured to communicatively couple the AU 610 to the I/O circuitry such that the I/O circuitry 612 is capable of routing signals to and from the AU 610 to one or more other components of the processing system 600. Further, the PCIe connectors 638 are configured to communicatively couple the I/O device 608 to the I/O circuitry 612 such that the I/O circuitry 612 is capable of routing signals to and from the I/O device 608 to one or more other components of the processing system 600.

By way of example and not limitation, the I/O device 608 includes one or more keyboards, pointing devices, game controllers (e.g., gamepads, joysticks), audio input devices (e.g., microphones), touch pads, printers, speakers, headphones, optical mark readers, hard disk drives, flash drives, solid-state drives, and the like. Additionally, the I/O device 608 is configured to execute one or more operations, tasks, instructions, or any combination thereof based on one or more physical registers 640 of the I/O device 608. In one or more implementations, such physical registers 640 are configured to maintain data (e.g., operands, instructions, values, variables) indicating one or more operations, tasks, or instructions to be performed by the I/O device 608.

To manage communication between components of the processing system 600 (e.g., AU 610, I/O device 608) that are connected to PCI connectors 638, and one or more other components of the processing system 600, the I/O circuitry 612 includes PCI switch 642. The PCI switch 642, for example, includes circuitry configured to route packets to and from the components of the processing system 600 connected to the PCI connectors 638 as well as to the other components of the processing system 600. As an example, based on address data indicated in a packet received from a first component (e.g., CPU 602), the PCI switch 642 routes the packet to a corresponding component (e.g., AU 610) connected to the PCI connectors 638.

Based on the processing system 600 executing a graphics application, for instance, the CPU 602, the AU 610, or both are configured to execute one or more instructions (e.g., draw calls) such that a scene including one or more graphics objects is rendered. After rendering such a scene, the processing system 600 stores the scene in the storage 614, displays the scene on the display 626, or both. The display 626, for example, includes a cathode-ray tube (CRT) display, liquid crystal display (LCD), light emitting diode (LED) display, organic light emitting diode (OLED) display, or any combination thereof. To enable the processing system 600 to display a scene on the display 626, the I/O circuitry 612 includes display circuitry 644. The display circuitry 644, for example, includes high-definition multimedia interface (HDMI) connectors, DisplayPort connectors, digital visual interface (DVI) connectors, USB connectors, and the like, each including circuitry configured to communicatively couple the display 626 to the I/O circuitry 612. Additionally or alternatively, the display circuitry 644 includes circuitry configured to manage the display of one or more scenes on the display 626 such as display controllers, buffers, memory, or any combination thereof.

Further, the CPU 602, the AU 610, or both are configured to concurrently run one or more virtual machines (VMs), which are each configured to execute one or more corresponding applications. To manage communications between such VMs and the underlying resources of the processing system 600, such as any one or more components of processing system 600, including the CPU 602, the I/O device 608, the AU 610, and the system memory 606, the I/O circuitry 612 includes memory management unit (MMU) 646 and input-output memory management unit (IOMMU) 648. The MMU 646 includes, for example, circuitry configured to manage memory requests, such as from the CPU 602 to the system memory 606. For example, the MMU 646 is configured to handle memory requests issued from the CPU 602 and associated with a VM running on the CPU 602. These memory requests, for example, request access to read, write, fetch, or pre-fetch data residing at one or more virtual addresses (e.g., guest virtual addresses) each indicating one or more portions (e.g., physical memory addresses) of the system memory 606. Based on receiving a memory request from the CPU 602, the MMU 646 is configured to translate the virtual address indicated in the memory request to a physical address in the system memory 606 and to fulfill the request. The IOMMU 648 includes, for example, circuitry configured to manage memory requests (memory-mapped I/O (MMIO) requests) from the CPU 602 to the I/O device 608, the AU 610, or both, and to manage memory requests (direct memory access (DMA) requests) from the I/O device 608 or the AU 610 to the system memory 606. For example, to access the registers 640 of the I/O device 608, the registers 636 of the AU 610, and/or the AU memory 634, the CPU 602 issues one or more MMIO requests. Such MMIO requests each request access to read, write, fetch, or pre-fetch data residing at one or more virtual addresses (e.g., guest virtual addresses) which each represent at least a portion of the registers 640 of the I/O device 608, the registers 636 of the AU 610, or the AU memory 634, respectively. As another example, to access the system memory 606 without using the CPU 602, the I/O device 608, the AU 610, or both are configured to issue one or more DMA requests. Such DMA requests each request access to read, write, fetch, or pre-fetch data residing at one or more virtual addresses (e.g., device virtual addresses) which each represent at least a portion of the system memory 606. Based on receiving an MMIO request or DMA request, the IOMMU 648 is configured to translate the virtual address indicated in the MMIO or DMA request to a physical address and fulfill the request.

In variations, the processing system 600 can include any combination of the components depicted and described. For example, in at least one variation, the processing system 600 does not include one or more of the components depicted and described in relation to FIG. 6. Additionally or alternatively, in at least one variation, the processing system 600 includes additional and/or different components from those depicted. The 600 is configurable in a variety of ways with different combinations of components in accordance with the described techniques.

Many variations of using variable access latency with storage array extensions on stacked dies are possible based on the disclosure herein. Although features and elements are described above in particular combinations, each feature or element is usable alone without the other features and elements or in various combinations with or without other features and elements.

The various functional units illustrated in the figures and/or described herein (e.g., the control logic 112, the storage circuit 108, the storage circuit 110-1 through the storage circuit 110-N, the requestor 204, the processing elements 206, the cache layer 210, the cache layer 212-1 through the cache layer 212-N, the cache controller 214) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a CPU, a DSP, a GPU, a parallel accelerated processor, a plurality of microprocessors, one or more microprocessors in association with a DSP core, a controller, a microcontroller, an Application Specific Integrated Circuit (ASIC), a FPGA circuit, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read-only memory (ROM), a RAM, a register, cache memory, semiconductor memory devices, magnetic media such as internal hard disks and removable disks, magneto-optical media, and optical media such as a CD-ROM disk, or a digital versatile disk (DVD).

1. A system comprising:
a processor;
a storage array having a plurality of storage circuits implemented on different dies in a stack of dies; and
control logic implemented on a same semiconductor die as the processor and a first storage circuit in the stack of dies, the control logic operable to receive responses from the storage circuits in reply to storage circuit requests from the processor forwarded through the stack of dies, and output the responses to the processor according to a respective latency that delays each response based on a characteristic of a corresponding storage circuit that provides the response.

2. The system of claim 1, wherein the control logic is further operable to cause a different response latency between two or more storage circuits in the stack of dies based on different characteristics of the two or more storage circuits.

3. The system of claim 1, wherein the characteristic of the corresponding storage circuit comprises a stack position of the corresponding storage circuit.

4. The system of claim 1, wherein the characteristic of the corresponding storage circuit comprises a material of the corresponding storage circuit, and two or more of the storage circuits have different materials that cause the two or more of the storage circuits to have different response latencies.

5. The system of claim 1, wherein the characteristic of the corresponding storage circuit comprises a circuit technology of the corresponding storage circuit, and two or more of the storage circuits have different Static Random Access Memory circuit technologies with different numbers of cells that cause the two or more of the storage circuits to have different response latencies.

6. The system of claim 1, wherein the characteristic of the corresponding storage circuit comprises a storage capacity of the corresponding storage circuit, and two or more of the storage circuits have different storage capacities with different data transfer rates that cause the two or more of the storage circuits to have different response latencies.

7. The system of claim 1, wherein the characteristic of the corresponding storage circuit comprises a layout type of the corresponding storage circuit, and two or more of the storage circuits have different layout types with different crossing latencies or timing margins that cause the two or more of the storage circuits to have different response latencies.

8. The system of claim 1, wherein the control logic is further operable to:
receive the storage circuit requests from the processor;
forward the storage circuit requests through the stack of dies;
set the respective latency for each of the responses; and
for each of the responses, after waiting for the respective latency that is set for the response, check the stack of dies for the response and output the response to the processor.

9. The system of claim 1, wherein the control logic is operable to:
determine a respective worst-case latency for each storage circuit in the stack of dies; and
set the respective latency of each storage circuit to be the respective worst-case latency determined for that storage circuit.

10. The system of claim 1, wherein the control logic is operable to:
maintain a record of individual latencies associated with the storage circuits in the stack of dies; and
set the respective latency of each storage circuit to be an individual latency maintained in the record for that storage circuit.

11. (canceled)

12. (canceled)

13. (canceled)

14. A device comprising:
a cache controller that outputs responses from a cache to a processor, the cache implemented as a stacked storage array having a plurality of storage circuits, the cache controller outputs the responses according to a respective latency that delays each response based on a characteristic of a corresponding storage circuit that provides the response.

15. The device of claim 14, wherein the cache controller is operable to cause a different response latency between two or more storage circuits in the cache.

16. The device of claim 14, wherein the characteristic of the corresponding storage circuit comprises a stack position and the cache controller is operable to set the respective latency of a first storage circuit in the stacked storage array to be shorter than the respective latency of a last storage circuit in the stacked storage array.

17. The device of claim 16, wherein the cache controller is further operable to set the respective latency of a second storage circuit in the stacked storage array to be longer than the respective latency of the first storage circuit and shorter than the respective latency of the last storage circuit.

18. The device of claim 14, wherein the cache controller is further operable to:
maintain, within the cache controller, a record of individual latencies associated with the storage circuits in the stacked storage array; and
set the respective latency of each storage circuit to be an individual latency maintained in the record for that storage circuit.

19. The device of claim 14, wherein the cache controller is implemented on a same semiconductor die as a first storage circuit in the stacked storage array.

20. A method comprising:
receiving, by control logic, a request from a processor to a stacked storage array having a plurality of storage circuits implemented on a stack of dies, the control logic and the processor are implemented on a same semiconductor die from the stack of dies as a first storage circuit in the stacked storage array;
identifying, by the control logic, a characteristic of a corresponding storage circuit that generates a response to the request;
setting, by the control logic, a respective latency for the response based on the characteristic; and
delaying, by the control logic, an output of the response to the processor according to the respective latency determined for the response.

21. The system of claim 1, wherein the storage array is a cache for the processor, and the control logic is a cache controller that controls processor access to data located at the cache.

22. The method of claim 20, wherein the stacked storage array is a cache for the processor, and the control logic is a cache controller that controls processor access to data located at the cache.

23. The device of claim 14, wherein the cache controller controls processor access to data located at the cache by managing storage of the data to the cache, retrieval of the data from the cache, and transfer of the data between the processor and the cache.
